(19) United States
(12) Patent Application Publication
(10) Pub. No.: US 2026/0235300 A1
(43) Pub. Date: Aug. 13, 2026

(54) EXHAUST SYSTEM FOR USE IN KITCHEN APPLICATIONS

(71) Applicant: North American Kitchen Solutions, Incorporated, Elyria, OH (US)

(72) Inventors: Sacha Polakoff, Westlake, OH (US); David Allen Terifay, Statesville, NC (US)

(21) Appl. No.: 19/633,143

(22) Filed: Mar. 30, 2026

Related U.S. Application Data
(63) Continuation-in-part of application No. 18/351,141, filed on Jul. 12, 2023, now Pat. No. 12,611,910.

(51) Int. Cl. F24C 15/20; B60P 3/025

(52) U.S. Cl. CPC F24C 15/2021; B60P 3/0257

(57) ABSTRACT

A ventilation hood system includes a hood body defining an exhaust pressure chamber and a supply airflow chamber. The ventilation hood system includes an exhaust fan assembly configured to generate a pressure difference to pull cooking effluent into the exhaust pressure chamber and flow out of the ventilation hood system. The ventilation hood system also includes a supply air system configured to pull an ambient air into the supply airflow chamber and flow out of the ventilation hood system.

### CROSS-REFERENCE TO RELATED APPLICATIONS

This application is a continuation-in-part application and claims priority to U.S. Non-Provisional application Ser. No. 18/351,141, titled “Exhaust System for use in Kitchen Applications,” filed on Jul. 12, 2023, which is incorporated by reference herein in its entirely.

### FIELD OF INVENTION

This disclosure is generally directed to an exhaust system, such as a hood assembly, for use in an industrial or commercial setting that provides ventilation of cooking surfaces and areas in a kitchen. More specifically, this disclosure is related to an exhaust system for use in a mobile kitchen such as a food truck.

### BACKGROUND

Kitchen hoods are essential for maintaining clean and healthy kitchen environments by removing smoke and pollutants and reducing high air temperatures generated during cooking. Grease effluent produced during cooking can accumulate in the hood and ductwork, which reduces the efficiency of the hood and causes problems for the users. This grease buildup can also create an obstruction that can lead to reduced airflow, which increases the likelihood of fire. This is especially true in industrial settings, such as commercial kitchens, manufacturing plants, and mobile kitchens where significant amounts of grease particles can be generated by cooking or production processes. For mobile kitchens, such as food trucks, these issues are exacerbated by the relatively small internal area where the cooking takes place.

Kitchen hoods in kitchen environments are vented upwards, through the ceiling in the room. This is especially true in mobile kitchen applications, such as food trucks. While ceiling vented kitchen hoods are available for mobile kitchens, it may not be ideal to add a kitchen hood to the roof of the truck, which adds height and weight to the vehicle. It would be preferable to vent the exhaust from cooking operations from the side of the vehicle. However, doing so requires attention to protrusions from the vehicle and prevention of natural elements, such as wind, rain, and debris, from entering the kitchen hood. Therefore, the use of a low-profile kitchen hood incorporating these features would be beneficial.

Therefore, there is a need for more efficient and effective hood systems to maintain clean and healthy kitchen environments, especially mobile kitchen environments.

### SUMMARY

A hood for use in a kitchen includes a hood body that includes an inlet, a chamber, and two outlets. The hood body is configured to function as a duct system to guide cooking effluent to flow into the hood from the inlet, through the chamber, and out of the hood from the two outlets. The hood includes a blower assembly coupled to the hood body. The blower assembly include a motor and a blower wheel. The blower wheel includes primary blades configured to pull the cooking effluent from the inlet into the chamber. The blower wheel includes secondary blades configured to pull an ambient air flowing through a rear side of the hood adjacent to the motor and into the chamber. The blower assembly is configured to disperse the cooking effluent and the ambient air radially outward in a direction perpendicular to a center axis of the blower wheel such that the cooking effluent is expelled away from the motor.

Other elements of the hood include turning vanes disposed in the chamber in a staggered manner to direct the cooking effluent and the ambient air to exist the chamber from the two outlets. The turning vanes have a curvature configured to gradually change flow directions and increase flow speed. The curvature is about 100 degrees. The turning vanes are disposed on a bottom side of the chamber. A length of the turning vanes is about 70% of a height of the chamber.

Other elements of the hood include a metal mesh disposed at the inlet to reduce noise. A circular curved ring is disposed at the inlet to straighten a flow of the cooking effluent into the chamber. An external filter system is disposed at the two outlets. The external filter system comprises V-shaped louvers. The external filter system includes a first wire mesh and a second wire mesh that are overlapped one another such that an undulating pattern of the first wire mesh is substantially perpendicular to an undulating pattern of the second wire mesh.

In one embodiment, the hood is configured to be mounted to a side wall of a food truck. In one embodiment the hood is configured to reduce a temperature of the cooking effluent to about or below 90° F. when it exits the hood at the two outlets.

A mobile kitchen includes a hood that includes a hood body including an inlet, a chamber, and two outlets. The hood body is configured to function as a duct system to guide cooking effluent to flow into the hood from the inlet, through the chamber, and out of the hood from the two outlets. The hood includes a blower assembly coupled to the hood body. The blower assembly includes a motor and a blower wheel, which includes primary blades configured to pull the cooking effluent from the inlet into the chamber and secondary blades configured to pull an ambient air flowing through a rear side of the hood adjacent to the motor and into the chamber. The blower assembly is configured to disperse the cooking effluent and the ambient air radially outward in a direction perpendicular to a center axis of the blower wheel such that the cooking effluent is expelled away from the motor.

Other elements of the mobile kitchen include turning vanes disposed in the chamber in a staggered manner to direct the cooking effluent and the ambient air to exist the chamber from the two outlets. The turning vanes have a curvature configured to gradually change flow directions and increase flow speed. The curvature is about 100 degrees. The turning vanes are disposed on a bottom side of the chamber. A length of the turning vanes is about 70% of a height of the chamber.

In one embodiment, the mobile kitchen is configured to be mounted to a side wall of a food truck.

In other embodiments, a ventilation hood system includes a hood body defining an exhaust pressure chamber and a supply airflow chamber. The ventilation hood system includes an exhaust fan assembly configured to generate a pressure difference to pull cooking effluent into the exhaust pressure chamber and flow out of the ventilation hood system. The ventilation hood system also includes a supply air system configured to pull an ambient air into the supply airflow chamber and flow out of the ventilation hood system.

The exhaust fan assembly includes a motor and a blower wheel. The blower wheel includes primary blades configured to pull the cooking effluent from an inlet into the exhaust pressure chamber. The blower wheel also includes secondary blades configured to pull an ambient air flowing through a rear side of the hood body adjacent to the motor and into the exhaust pressure chamber. The blower assembly is configured to disperse the cooking effluent and the ambient air radially outward in a direction perpendicular to a center axis of the blower wheel such that the cooking effluent is expelled away from the motor.

In other embodiments, a mobile kitchen includes a ventilation hood system that includes a hood body defining an exhaust pressure chamber and a supply airflow chamber. The ventilation hood system includes an exhaust fan assembly configured to generate a pressure difference to pull cooking effluent into the exhaust pressure chamber and flow out of the ventilation hood system. The ventilation hood system also includes a supply air system configured to pull an ambient air into the supply airflow chamber and flow out of the ventilation hood system.

### BRIEF DESCRIPTION OF THE DRAWINGS

The accompanying figures, which are incorporated in and constitute a part of the specification, illustrate various example configurations and data, and are used merely to illustrate various example embodiments. In the figures, like elements bear like reference numerals.

FIG. 1 is a side view of one embodiment of a food truck equipped with the hood of the present disclosure.

FIG. 2 is a rear view of one embodiment of a food truck equipped with the hood of the present disclosure.

FIG. 3 is an isometric view of one embodiment of a food truck equipped with the hood of the present disclosure.

FIG. 4 is a top view of one embodiment of a food truck equipped with the hood of the present disclosure.

FIG. 5 is a perspective view of one embodiment of the hood of the present disclosure.

FIG. 6 is a perspective view of one embodiment of the hood without baffle filters.

FIG. 7 is an exploded view of one embodiment of a hood body of the hood of the present disclosure.

FIG. 8 is a perspective view of one embodiment of an inlet into a hood body.

FIG. 9 is a side view of one embodiment of a portion of a hood body.

FIG. 10 is a perspective view of one embodiment of a portion of a hood body.

FIG. 11 is a top sectional view of one embodiment of a portion of a hood body.

FIG. 12 is a perspective sectional view of one embodiment of a blower assembly of the hood.

FIG. 13 is a perspective view of one embodiment of a blower wheel of the blower assembly of FIG. 12.

FIG. 14 is an exploded view of one embodiment of an external filter system.

FIG. 15 is a cross-sectional and detail view of an internal set of louvers disposed within one embodiment of an external filter system.

FIG. 16 is an exploded view of one embodiment of an external filter of the external filter system.

FIG. 17 is an exploded view of one embodiment of overlapping wire meshes of the external filter.

FIGS. 18-21 are different views of one embodiment of a hood illustrating flows of ambient air and kitchen effluent into and out from the hood.

FIG. 22 shows an embodiment of a ventilation hood system.

FIG. 23 is a perspective view of of the ventilation hood system of FIG. 22.

FIG. 24 is a partial top view of the ventilation hood system of FIG. 22.

FIG. 25 shows different views of an exhaust pressure chamber and supply airflow chamber of the ventilation hood system of FIG. 22.

FIG. 26 shows different views of an exhaust pressure chamber of the ventilation hood system of FIG. 22.

FIG. 27 is a side view of the ventilation hood system of FIG. 22.

FIG. 28 shows different views of one embodiment of the ventilation hood system of FIG. 22 illustrating flows of ambient air and cooking effluent into and out from the hood system.

FIG. 29 is a partial perspective view of an exhaust fan assembly of the ventilation hood system of FIG. 22.

### DETAILED DESCRIPTION

Kitchen hoods are essential for maintaining clean and healthy kitchen environments by removing smoke and pollutants and reducing high air temperatures generated during cooking. This is especially essential for kitchens in industrial settings, such as commercial kitchens, manufacturing plants, and mobile kitchens such as food trucks. In such environments, significant amounts of grease particles can be generated during cooking or production processes. The grease buildup can create an obstruction that can lead to reduced airflow and increase the likelihood of fire.

To address the need for a more efficient and effective kitchen hood especially for industrial settings, the present disclosure provides a kitchen hood with a hood body functioning as ductwork for grease removal and temperature reduction. In particular, the hood body functioning as ductwork is designed with airflow guiding features to direct and spin airflow, which enables more effective grease removal from the kitchen environment. The hood includes an integrated blower wheel and motor system that provides high-performance suction and air filtering through high air flow velocity. The high suction capacity helps ensure the kitchen environment remains clean and free from smoke and pollutants. Additionally, the airflow guiding features of the hood body can increase the contact between air flowing through the hood and the surface areas of the hood, such that the effluent is cooled more efficiently and further increases the hood's efficiency removing grease.

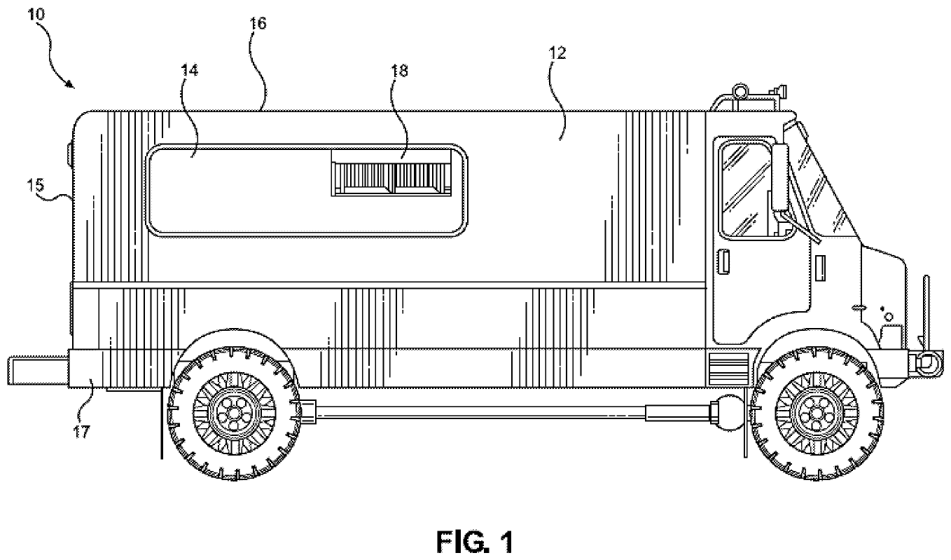

Although the kitchen hood disclosed herein is designed for kitchens in industrial settings, it may be used in any kinds of kitchens or cooking surfaces. FIG. 1 illustrates an example of a kitchen hood installed in a food truck Such hoods are generally equipped with an exhaust system, which facilitates ventilation of heat created by the use of a stove, deep fryer, or other cooking surface in a confined space. In most mobile kitchens, the stove or cooking surface is disposed below the hood, with the heat and grease generated by the cooked of food radiates upwardly therefrom. In the illustrated example, different from most mobile kitchens, the kitchen hood disclosed herein allow kitchen exhaust to be ventilated directly through a side wall of a space or structure, such as a small kitchen, without the need for extensive ductwork or an external fan or blower.

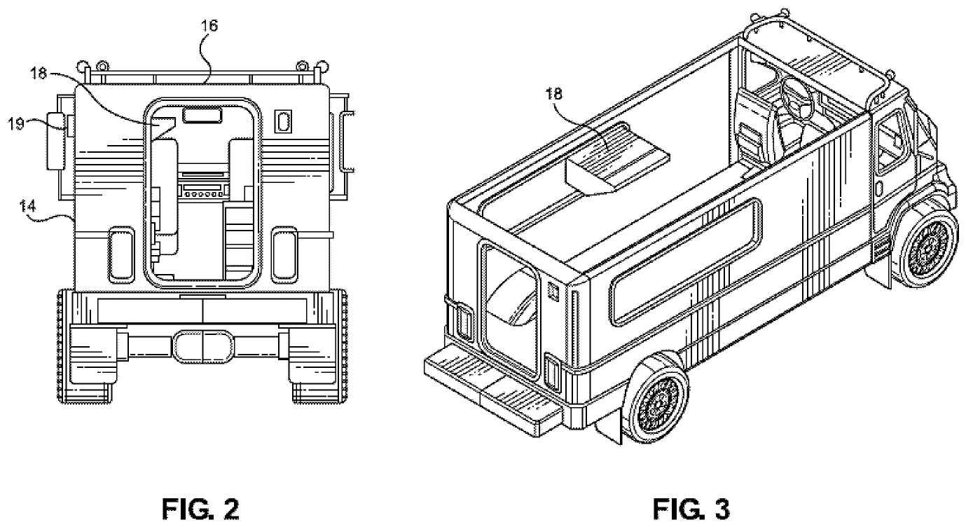

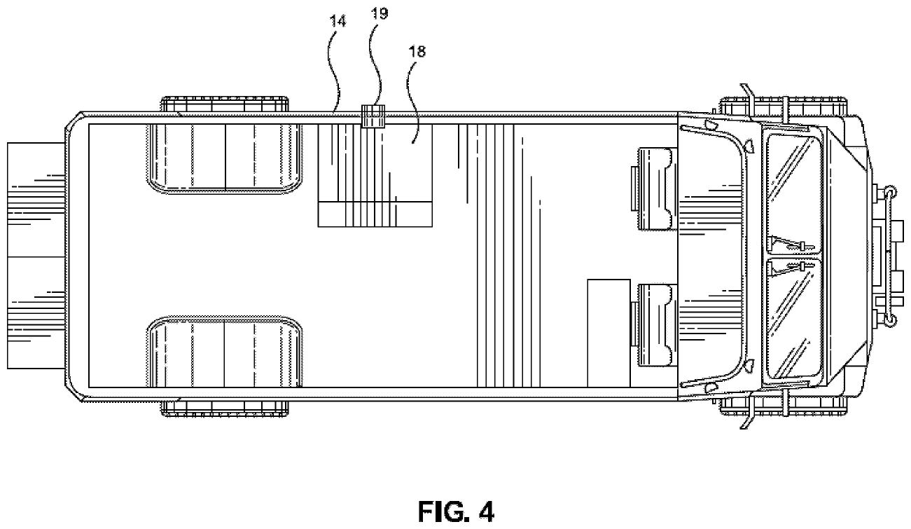

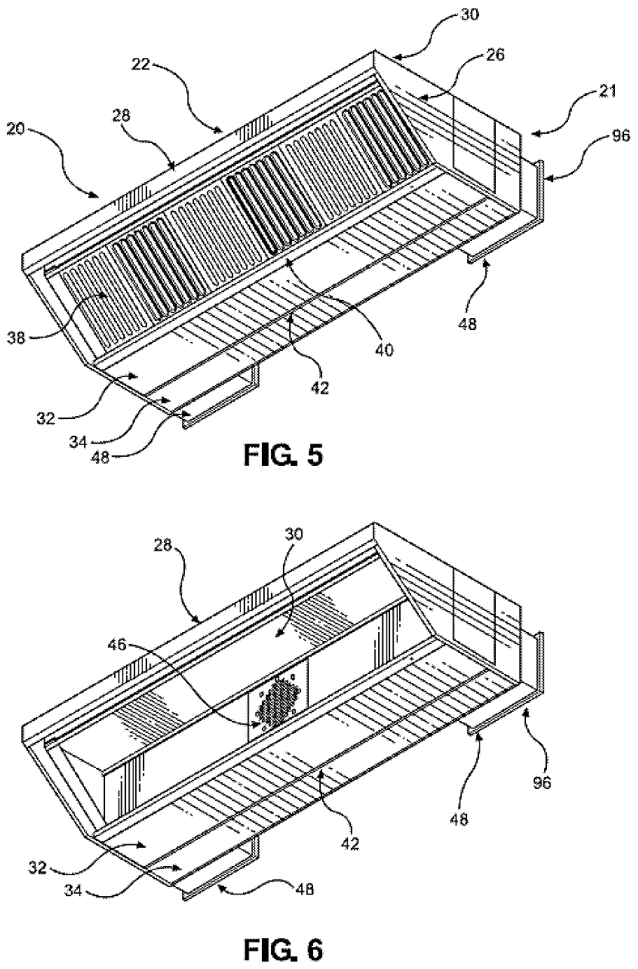

As shown in FIG. 1, a food truck 10 generally includes substantially vertical walls (for example a left side wall 12, a right side wall 14, and a back wall 15), a roof 16, and a floor 17. In one embodiment, a ventilation system 18 (hereinafter “a hood”) may be mounted to either side wall 12 or 14. By way of example, and as shown in FIGS. 1-3, the hood 18 may be mounted to the right side wall 14. Optionally, the hood 18 may also be secured to the roof 16. In addition, as shown in FIGS. 2 and 4, the hood 18 may be vented directly through the left side wall 14 at an exhaust exit 19.

It should be appreciated that the exact style of the hood 18 may vary, depending on the configuration of the kitchen. However, in one embodiment, the ventilation system 14 may be configured to ventilate air from within the hood 18 through any one or a combination of the substantially vertical walls (the left side wall 12, the right side wall 14, and the back wall 15), the roof 16, and the floor 17 of the food truck 10. For example, in one embodiment, an opening may be created through the left side wall 14 of the food truck 10. In this embodiment, the hood 18 may then be mounted to the left side wall 14 so that the hood 18 covers the opening. The operator of the food truck 10 may then optionally cover the opening on the outside of the truck 10 with a louvered covering (as described below) to prevent rain and other contaminants from entering the kitchen.

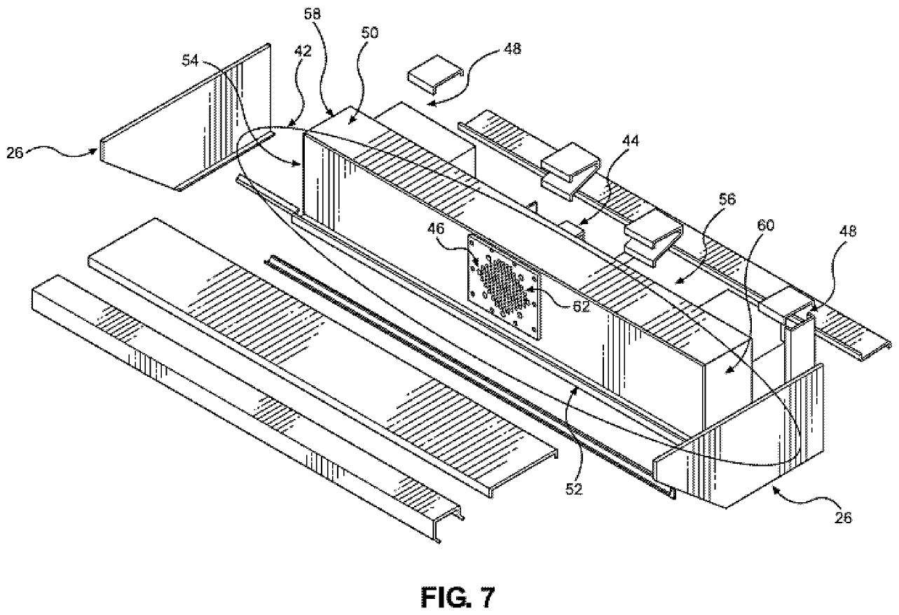

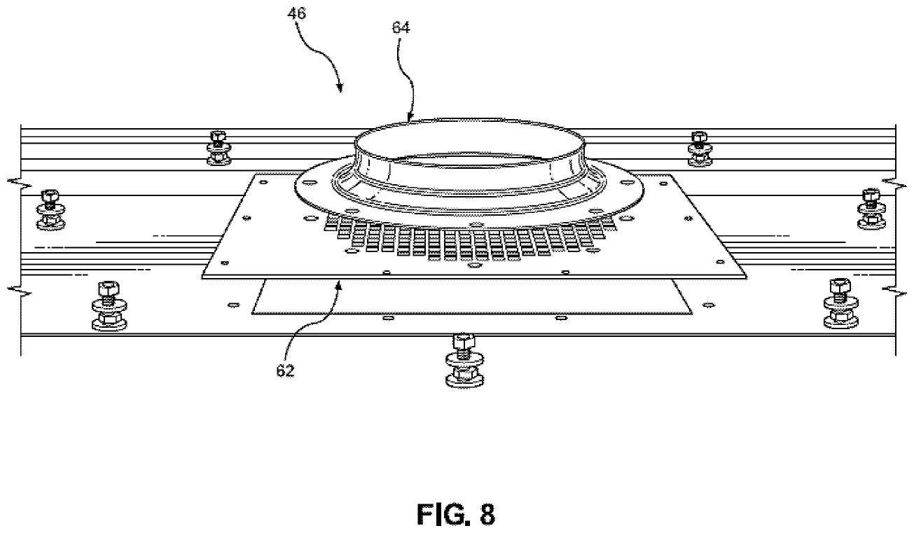

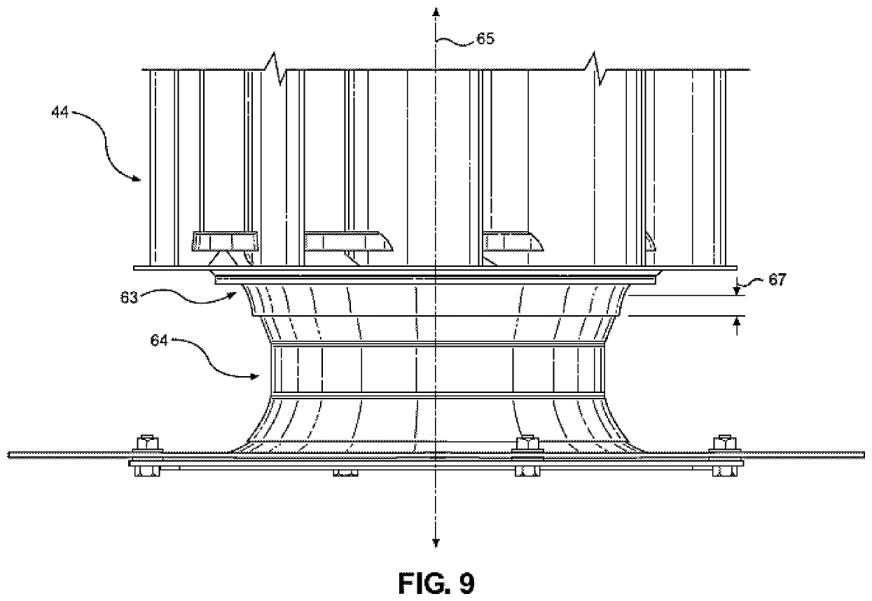

Now referring to FIGS. 5-7, the hood 18 is oriented with respect to the cooking effluent that enters the hood 18 from a front side 20 and exits the hood 18 from a rear side 21. The hood 18 includes a hood body 22 that is configured to function as ductwork for grease removal and temperature reduction. In particular, the hood body 22 functions as ductwork to direct and spin airflow, which leads to effective grease effluent removal from the kitchen environment. The hood body 22 is defined by side panels 26, a front panel 28, a top panel 30, a lower panel 32, and an angle panel 34 extending from the rear side to the lower panel 32. These panels (the side panels 26, the front panel 28, the top panel 30, the lower panel 32, and the angle panel 34) are connected to one another to function as ductwork. These panels may be connected to one another using any suitable removably or non-removably mechanism for connecting the components to function as ductwork. For example, these panels may be connected via an adhesive, wedding, mechanical fastening, snap fit, interference fit, clearance fit, etc. These panels may be made of stainless steel, aluminized or galvanized steel, or other suitable materials.

In an installed hood 18 (e.g., the hood 18 in an installed orientation) the side panels 26 and the front panel 28 are oriented vertically (e.g., vertical in relation to the cooking surface or the floor) and the top panel 30 and the lower panel 32 are oriented horizontally (e.g., horizontal in relation to the cooking surface or the floor). The side panels 26, the front panel 28, the top panel 30, the lower panel 32, and the angle panel 34 are designed with desired dimensions to form an inlet 36 that intakes the cooking effluent and suitable for the dimensions and/or configuration of the kitchen.

The hood 18 may include grease baffle filters 38 that are movably attached to and cover the inlet 36 and include a grease collection tray 40. The grease baffle filters 38 are configured to filter out the grease in the cooking effluent and the grease is then collected into the grease collection tray 40. The grease filter baffles 38 may have a smooth surface to prevent the grease from adhering to them. The grease particles are collected on the grease filter baffles 38 and eventually fall into the grease collection tray 40. The grease collection tray 40 can be easily removed and cleaned, making maintenance of the hood 18 easier and less time-consuming.

The hood body 22 includes a chamber 42 coupled to a blower assembly or a fan 44, and the blower assembly 44 and the chamber 42 are configured to work collectively to allow compression of the cooking effluent to increase the efficiency of the blower assembly 44 to exhaust the cooking effluent out of the kitchen.

The chamber 42 is generally a right rectangular prism (e.g., two parallel end faces and four lateral faces, each one of which is a rectangle; the faces are perpendicular to each of its bases) in shape and is configured to function as ductwork. In particular, the chamber 42 is configured to enclose the cooking effluent and direct it from an inlet 46 to two outlets 48. The suction generated by the blower assembly 44 pulls the cooking effluent from the space enclosed by the hood body 22 in the front side 20 through the inlet 46 into the chamber 42 and exit through the two outlets 48. The chamber 42 includes an upper horizontal side 50, a lower horizontal side 52, front vertical side 54, rear vertical side 56, left vertical side 58, and right vertical side 60. The inlet 46 is disposed on the front vertical side 54 and the blower assembly 44 and the two outlets 48 are disposed on the rear vertical side 56. The blower assembly 44 is relatively at the center of the rear vertical side 56 and the two outlets 48 are on the left and right sides of the blower assembly 44.

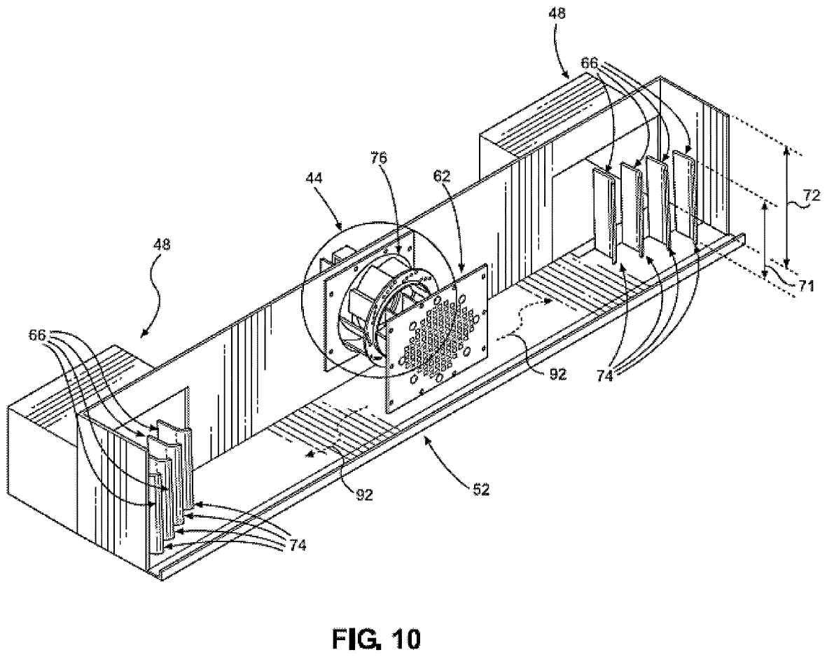

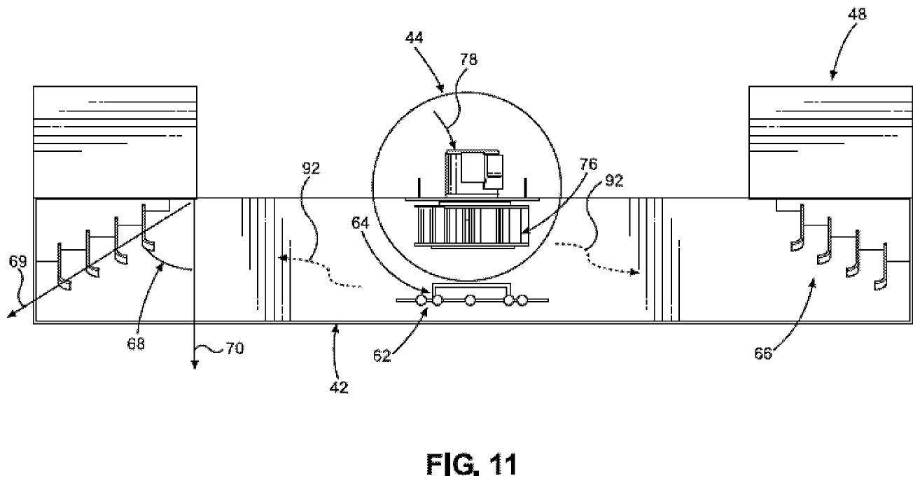

As shown in FIG. 8 and FIG. 9, the inlet 46 includes a metal mesh 62 and a passage 64. The metal mesh 62 is configured to reduce the nose level and the passage 64 is configured to straighten the cooking effluent and direct it towards the blower assembly 44. The passage 64 and the blower assembly 44 may be positioned such that the passage 64 overlaps a passage 63 into the blower assembly 44 to allow smooth airflow. As shown in FIG. 9, the passage 63 and the passage 64 overlaps in an axial direction 65. A depth 67 of the overlap may be up to one inch (e.g., about 0.1″ to 1.0″, about 0.5″ to 1.0″, about 0.8 to 1.0″, etc.).

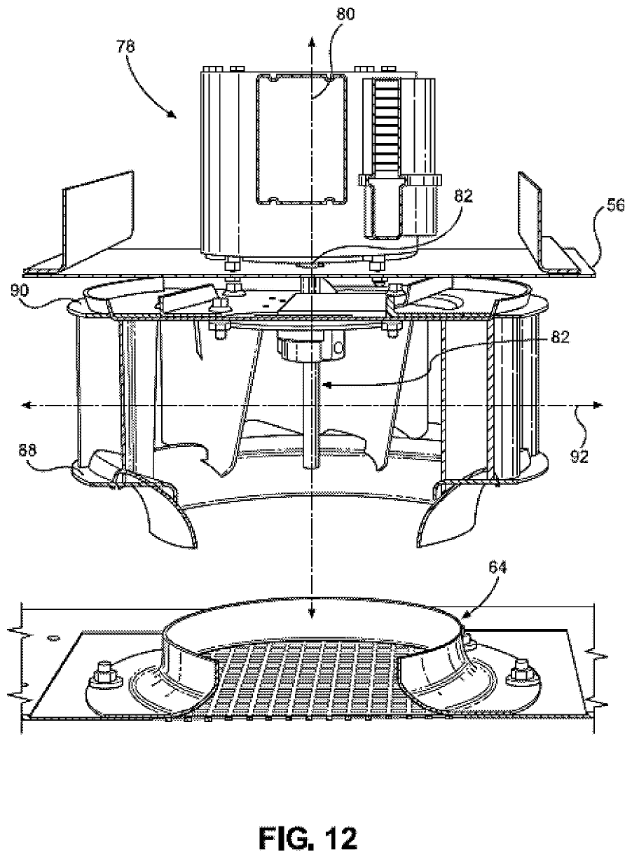

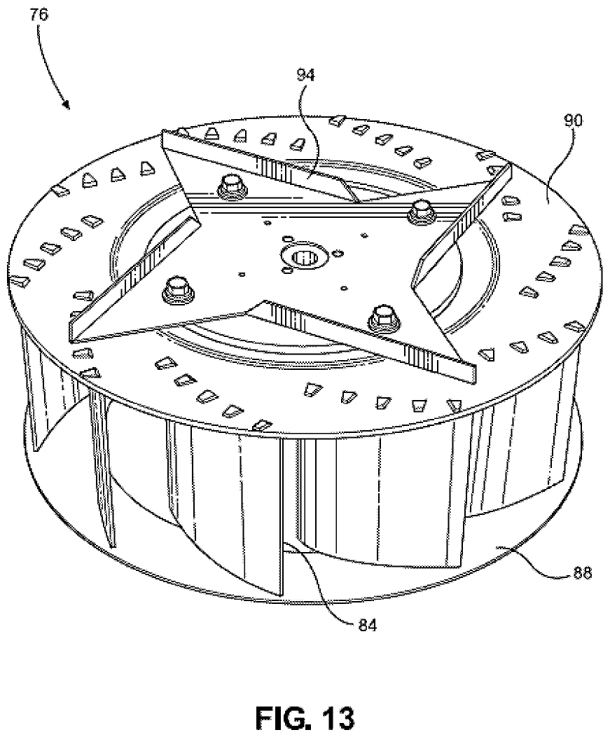

As shown in FIGS. 10 and 11, the hood body 22 includes turning vanes 66 disposed inside the chamber 42 in front of the two outlets 48. The turning vanes 66 are attached to the lower horizontal side 52 of the chamber 42. The turning vanes 66 are shaped and arranged in any suitable manner to guide the flow of the cooking effluent and create a smooth natural flow path for the cooking effluent to exit the chamber 42 through the two outlets 48. For example, the turning vanes 66 are arranged in a staggered manner with an offset angle 68 (e.g., the angle between a staggered axis 69 and an orthogonal axis 70 of the two outlets 48). The offset angle 68 may be about 20-70 degrees, about 30-60 degrees, about 40-50 degrees, or about 45 degrees.

The turning vanes 66 are designed to have an aerodynamically smooth curvature suitable to guide the flow of the cooking effluent. For example, the turning vanes 66 may have a length 71 relative to a height 72 of the chamber 42, the length 71 may be about 50-100%, about 60-90%, about 80-70%, or about 75% of the height 72. The turning vanes 66 may all have the same length 71 or may have different lengths 71, or the length 71 may increase or decrease in the direction of the staggered axis 69. The turning vanes 66 have a curvature 74 of any suitable degrees, e.g., about 100-160 degrees, about 100-150 degrees, about 100-140 degrees, about 100-130 degrees, about 120 degrees, or about 110 degrees.

Furthermore, the turning vanes 66 are designed to accelerate the airflow speed based on Bernoulli's principles. When airflow encounters the turning vane 66, it divides into two main streams. The stream passing over an outer side of the curve has a longer distance to travel compared to that along an inner side of the curve. Based on Bernoulli's principles, the airflow over the outer side must accelerate to cover the longer distance at the same time as the airflow along the inner side of the curve. This pressure difference between the outer and inner sides creates a net force perpendicular to the airflow, which increases the net airflow.

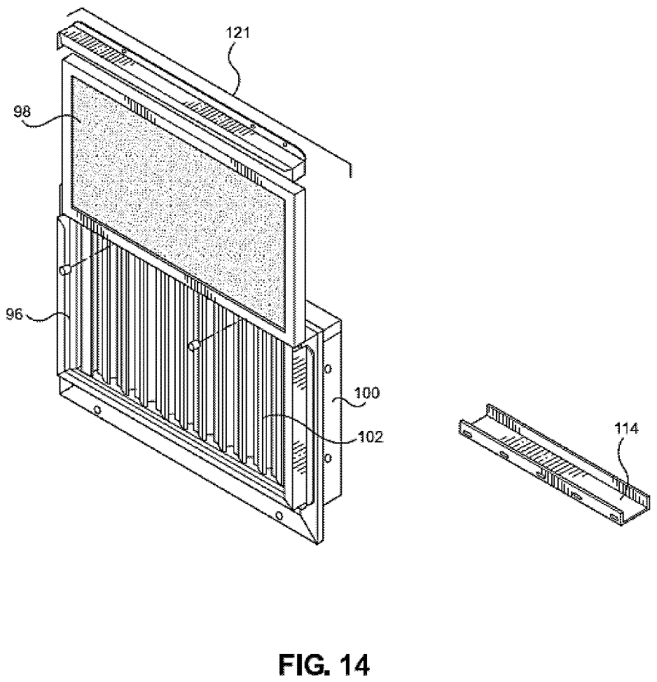

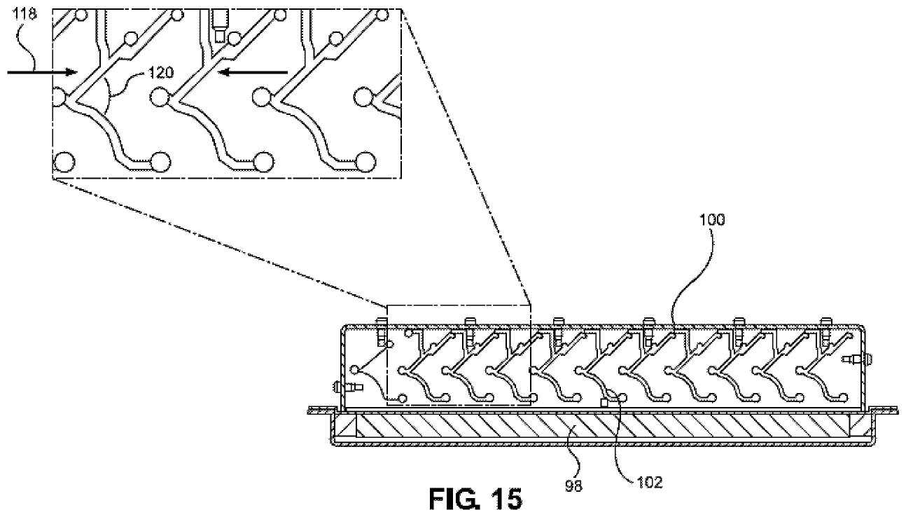

As shown in FIGS. 12-13, the blower assembly 44 includes a blower wheel 76 (e.g., a direct drive type blower wheel) and a motor 78 arranged along a center axis 80 (e.g., along a shaft 82). The blower wheel 76 is disposed inside the chamber 42 adjacent to the rear vertical side 56. The motor 78 is disposed on the opposite end of the blower wheel 76 outside the chamber 42, adjacent to the rear vertical side 56. There is an opening 82 on the rear vertical side 56 of the chamber 42 (the hood body 22) to accommodate the shaft 82 through.

The blower wheel 76 includes primary blades 84 disposed about the shaft 82 between a font side 88 and a rear side 90 of the blower wheel 76. The primary blades 84 are configured to pull the kitchen eluent and disperse it outwardly in a radial direction 92 (e.g., perpendicular to the center axis 80).

The blower wheel 76 further includes secondary blades 94 disposed between the rear side 90 of the blower wheel 76 and the rear vertical side 56 of the chamber 42. The secondary blades 94 maybe mounted on the rear side 90. The secondary blades 94 are configured to pull ambient air from the side of the motor 78 (from outside the hood 18). Once the ambient air enters the chamber 42 it is dispersed outward radially (in the radial direction 92) and joins the cooking effluent flow. For example, there are two streams of airflow inside the chamber 42. The first stream of airflow (e.g., the cooking effluent) is mainly driven/dispersed by the primary blades 84, the second stream of airflow is mainly driven/dispersed by the secondary blades 94, the first and second streams of airflow join/mix and exit the two outlets 48.

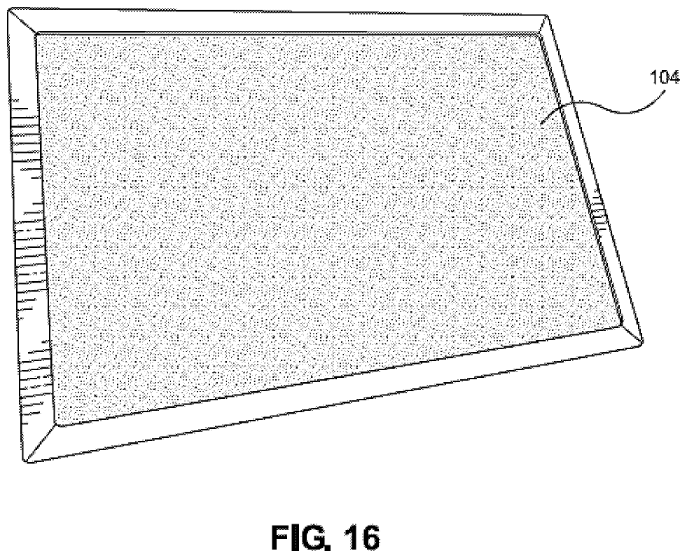

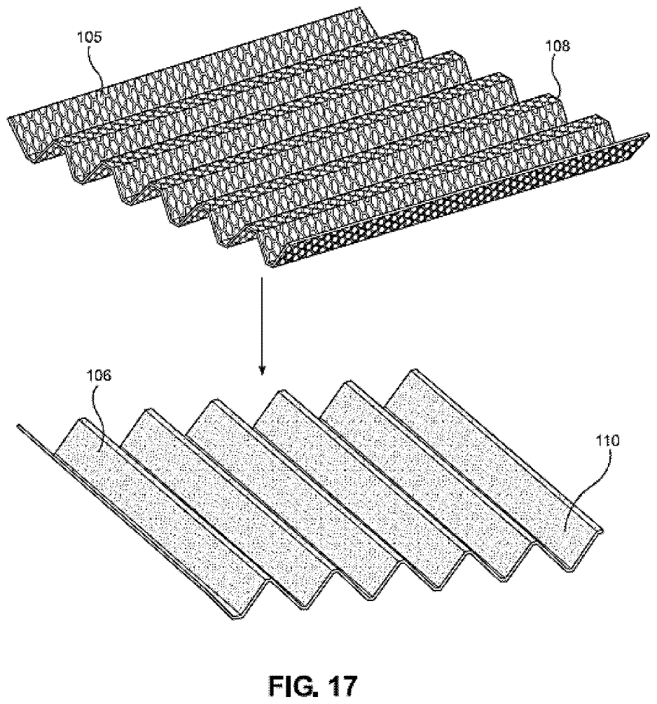

As shown FIGS. 14-15, the hood 18 may include baffle louvers 96 attached to the two outlets 48 (e.g., venting ports of the ductwork). The baffle louvers 96 may generally have a V-shape or curve which further accelerate the airflow (based on Bernoulli's principle) to at least partially compensate the speed loss due to friction flowing through the chamber 42.

The hood 18 may include an external filter 98 configured to break up and smooth the flow of the cooking effluent. For example, the external filter 98 may be made of 3 layers of opposing meshes which baffle the cooking effluent and enable the use of the entire louver area of the baffle louvers 96 (as opposed to using only the higher speed area over the baffles). The 3 layers of meshes help more uniformly spreading the airflow across the baffle louvers 96 so it does not overpower one portion of the baffle louvers 96.

The baffle louvers 96 may include a louver frame body 100, a set of V-shaped louvers 102, and the external filter 98 slidably (as shown in FIG. 13) disposed within the louver frame body 100. The external filter 98 may be removed in order to easily clean the filter and remove any grease or particulates that may be built up on the internal surface of the filter. The exact style of the external filter 98 may vary, depending on at least the filtering efficiency requirements.

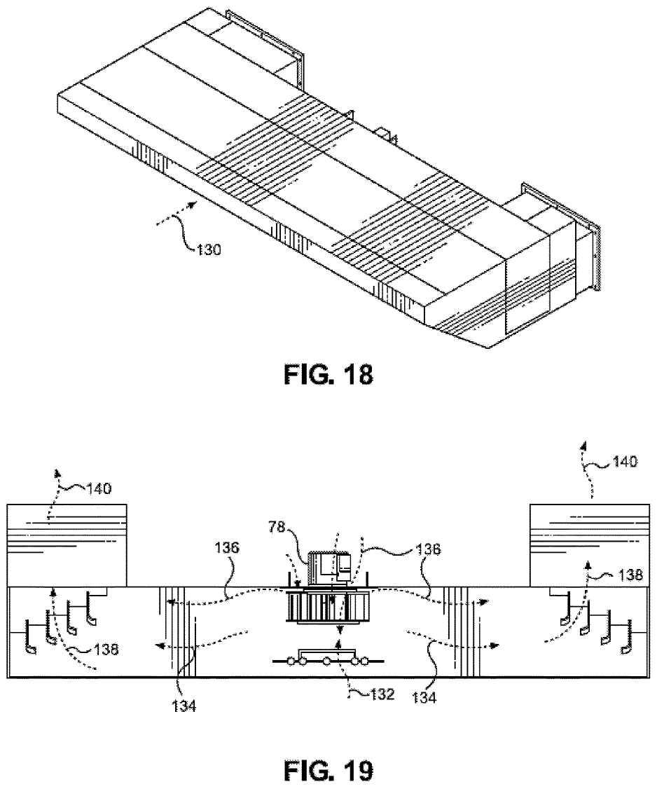

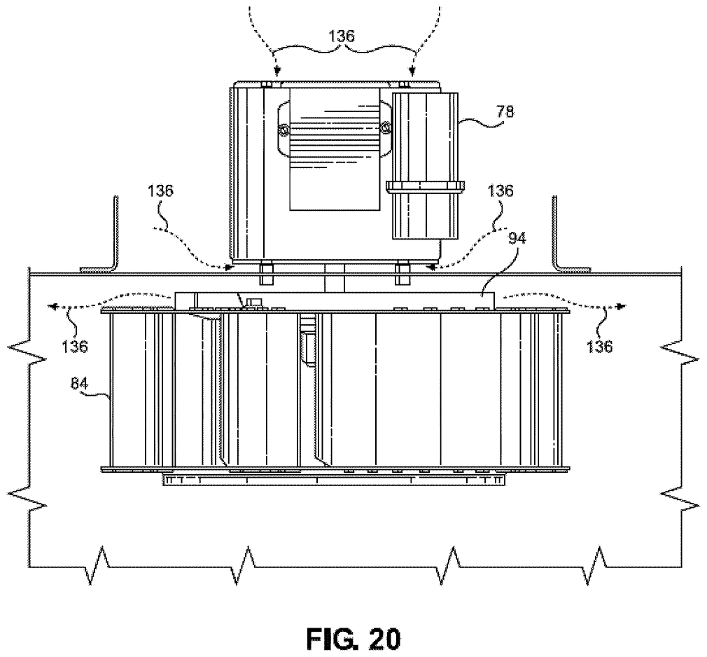

In one embodiment, as shown in FIGS. 16-17, the external filter 98 may include a mesh design with at least one wire mesh 104. In one embodiment, the external filter 98 include two wire meshes 105 and 106 have undulating pattern 108 and 110 (e.g., a smoothly rising and failing form or outline), respectively. The first and second wire meshes 105 and 106 may overlap one another in any suitable manner to adjust the filtering effects. In one embodiment, as shown in FIG. 16, the first and second wire meshes 105 and 106 are overlapping one another such that the undulating pattern 108 of the first wire mesh 105 is substantially perpendicular to the undulating pattern 110 of the second wire mesh 106. As may be appreciated, the external filter 98 may include more than or less than two sheets of wire meshes (e.g., one sheet, three sheets), and the wire meshes may overlap one another such that the undulating patterns are at any suitable angles relative to one another. The wire meshes 105 and 106 may be formed of any suitable sizes and patterns, for example, square and/or diamond, and the mesh size may be about 0.02 inches by 0.02 inches (about 0.05 cm by about 0.05 cm) to about 0.88 inches by about 0.88 inches (about 2.24 cm by about 2.24 cm). The wire meshes 104 and 106 may be made of any suitable material, for example, metals, metal alloys, polymers, textiles, etc.

The set of V-shaped louvers 102 are disposed within the frame body 100 and function to facilitate the transfer of the cooking effluent towards the external filter 98 while prevent rain from penetrating the hood 18 from outside. A V-shaped angle 112 of the louvers 102 may be about 30 to about 120 degrees, about 30 to about 100 degrees, about 30 to about 90 degrees, about 40 to about 70 degrees, about 51 to about 60 degrees. The louvers 102 may be generally vertically attached to the back of the frame body 100 and may be formed of a single piece of material or a combination of pieces combined to form each louver 102. As rain hits the louvers 102, it is directed downward to water drains 114 disposed in a bottom portion of the frame track, preventing water from entering the two outlets 48 into the hood body 22. The distance 118 between the louvers 102 and/or the angle 120 of the louvers 102 may vary to effectively direct and prevent water from entering the vent duct (the exhaust exit 19), the motor 78, and the blower wheel 76. In one embodiment, the distance 118 may be about 6% to about 12% of a lateral dimension (the length) 121 of the frame body 100 may be about 1 inch to about 1.65 inches (about 2.54 cm to about 4.19 cm). In one embodiment, and the angle 120 may be about 51 degrees to about 60 degrees.

The louvers 102 may be attached to the rear side 21 of the hood body 22 via any suitable removably or non-removably mechanism for connecting the components, for example, via an adhesive, wedding, mechanical fastening, snap fit, interference fit, clearance fit, etc.

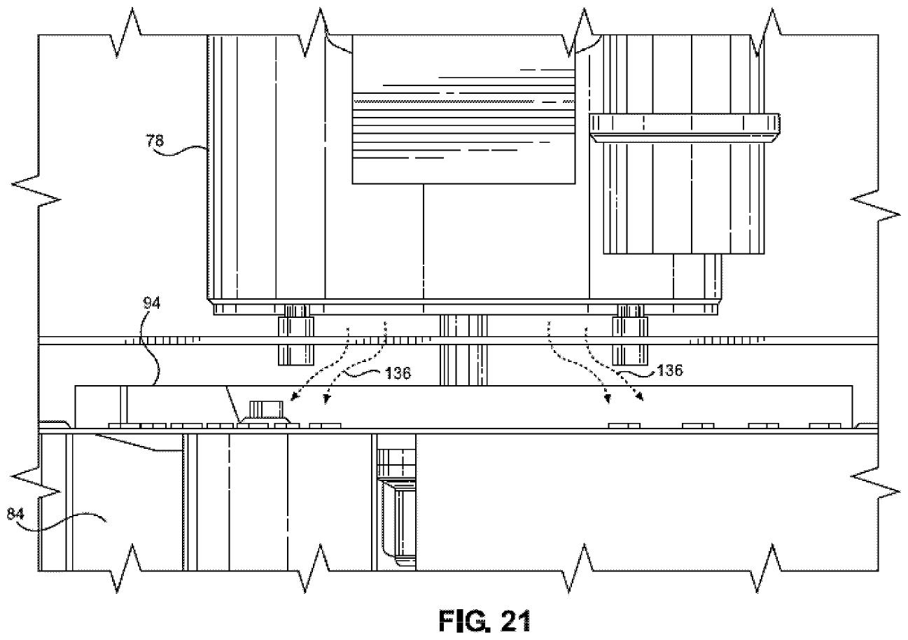

The hood 18 disclosed herein is designed to direct airflows in a manner to achieve a high hood efficiency. The cooking effluent contains smoke, pollutants, grease, etc. and may have a high temperature. The specific design of the hood 18 ventilates the cooking effluent in a manner such that the exhaust air discharged by the hood 18 is clean and with a significantly reduced temperature (e.g., the discharge air may be lower than 90° F.), which also benefits the hood 18 and especially the motor 78 to function more efficiently and greatly reduces the chance of motor overheating. The air/cooking effluent flow through the various components of the hood 18 is discussed in FIGS. 18-21, demonstrating how their specific designs contribute to the high hood efficiency.

As indicated by arrows 130, the cooking effluent is pulled into the hood 18. At this stage the cooking effluent has a high temperature and high contents of smoke, pollutants, grease, etc. The hood 18 is configured to speed up the cooking effluent (e.g., pulled by the blower assembly or the fan 44) such that cooking effluent is pulled int the hood 18 with an airflow speed up to about 4000 feet per minute (FPM) (as opposed to about 500 FPM-2200 FPM accordingly to industry standard). When the cooking effluent is sped up to such high speed, the grease in the effluent is extracted from the airflow. As the cooking effluent enters the hood body 22, it is filtered by the baffle filters 38 to filter out a substantial portion of grease from the cooking effluent. The grease remains on the side of the baffle filters 38 facing the inlet 36 of the hood 18. The grease is collected in the tray 40, which is easily removeable and cleaned. This allows clean ductwork and reduced maintenance.

As indicated by arrows 132, the filtered cooking effluent then flows through the metal mesh 62 (configured to reduce the noise level) and the passage 64 (configured to straighten the airflow) of the inlet 46 and into the chamber 42. The inlet 46 and the blower wheel 76 may be substantially concentric along the axial axis 80 of the blower wheel 76, and the overlap between the passage 63 into the blower assembly 44 and the passage 64 of the inlet 46 may be up to one inch, to allow smooth airflow.

As indicated by arrows 134, the cooking effluent, propelled by the rotating primary blades 84, is dispersed in the radial direction 92 of the blower wheel 76 and away from the motor 78. By dispersing the cooking effluent away from the motor 78, it greatly reduces the extent of the grease and high-temperature airflow, coming into contact with the motor 78.

As indicated by arrows 136, the ambient air, pulled by the rotating secondary blades 94 also enters the chamber 42. Subsequently, the ambient air, propelled by the rotating primary blades 84, is also dispersed in the radial direction 92 of the blower wheel 76 and joins and mixes with the flow of the cooking effluent (indicated by arrows 134).

It may be appreciated that since the ambient air (indicated by arrow 136) has a much lower temperature, the addition of which into the hood 18 can significantly reduce the overall temperature inside the hood 18. The ambient air allows the cooking effluent temperature to be reduced to below 90° F. while the hood material is designed to withstand 1000° F. The reduction in air temperature inside the chamber 42 improves the efficiency of the blower assembly 44 by generating a venturi effect into the chamber 42. The flow of the ambient air through the opening 82 into the chamber 42 also provides convection and conduction cooling of the motor 78.

The pressure difference between the ambient pressure and the pressure inside the chamber 42 is induced by the blower assembly 44. This pressure difference is at least 0.25 Kilopascal (KPa).

As indicated by arrows 138, the combined airflow (including the cooking effluent indicated by arrows 134 and the ambient air indicated by arrows 136) hits the turning vanes 66 which change the flow direction by about 90 degrees towards the two outlets 48. The turning vanes 66 are configured to create a smoother and more gradual change of direction and allow the airflow to pickup on flow velocity.

As indicated by arrows 140, the combined airflow is discharged from the hood 18 through the two outlets 48. The combined airflow flows through the baffle louvers 96 and then through the external filter 98 and exits the hood 18. The flow speed of the combined airflow is accelerated by the curves of the baffle louvers 96. The external filter 98 is configured to substantially filter out the remaining pollutants, grease, etc. The discharged air as indicated by arrows 140 is substantially clean and has a significantly lower temperature than that of the cooking effluent entering the hood 18. The temperature of the discharged air may be as low as about 90° F.

In general, as the cooking effluent and the ambient air enter the chamber 42, the flow direction changes by about 90 degrees as dispersed by the blower assembly 44, and the flow direction again changes by about 90 degrees as it exits the two outlets 48.

It should be appreciated that as the hood 18 is configured to synergistically remove and cool the cooking effluent. The hood 18 is able to remove the cooking effluent effectively and quickly owing to several factors. First, the presence of the turning vanes 66 and the baffle louvers 96 are configured to guide and accelerate the airflow. Second, the ambient air pulled in by the secondary blades 94 helps cooling the motor 78, thereby increases the efficiency of the blower assembly 44.

The presence of grease contributes significantly to the high temperature of the cooking effluent. As the cooking effluent is pulled quickly, owing to the high flow speed of the cooking effluent, the grease is separated out from the cooking effluent and filtered efficiently. This leads to fast elimination or at least fast reduction in the grease content (e.g., per cooling event the amount of the grease generated is not replenished). As the amount of grease is significantly reduced or eliminated, the temperature of the cooking effluent also decreases. The addition of the ambient air of lower temperature also helps reduce the temperature of the cooking effluent.

The faster flow speed leads to faster cooling, and the faster cooling leads to more efficient air pulling of the blower assembly 44. As such, the synergetic effects are achieved.

Table 1 shows suction capacities of the hood 18 with and without the turning vanes 66. The suction capacity is measured in cubic feet per minute (CFM). These results show that for kitchen effluent of the same temperature, the hood 18 with the turning vanes 66 demonstrates higher suction capacity to achieve the targeted grease capture and containment level. At 700° F. cooking effluent temperature (e.g., the temperature measured near the inlet 36), the hood 18 without the turning vanes 66 pulls out greases at about 2482 CFM, whereas the hood 18 with the turning vanes 66 is able to pull out greases at a higher suction capacity of 2555 CFM. The suction capacity of the hood 18 is increased by about 2.9% due to the presence of the turning vanes 66. At 600° F. cooking effluent temperature, the hood 18 without the turning vanes 66 pulls out greases at about 1683 CFM, whereas the hood 18 with the turning vanes 66 is able to pull out greases at a higher suction capacity of 1767 CFM. The suction capacity of the hood 18 is increased by about 4.9% due to the presence of the turning vanes 66. At 400° F. cooking effluent temperature (e.g., the temperature measured near the inlet 36), the hood 18 without the turning vanes 66 pulls out greases at about 1295 CFM, whereas the hood 18 with the turning vanes 66 is able to pull out greases at a higher suction capacity of 1368 CFM. The suction capacity of the hood 18 is increased by about 5.6% due to the presence of the turning vanes 66. It should also be noted that in general it requires a higher suction capacity to pull greases out from cooking effluent of a higher temperature.

TABLE 1

| | Exhaust CFM at which |
|---|---|
| | the targeted grease |
| | capture and containment |
| | is achieved |
| 700° F. with turning vanes | 2555 |
| 700° F. without turning vanes | 2482 |
| 600° F. with turning vanes | 1767 |
| 600° F. without turning vanes | 1683 |
| 400° F. with turning vanes | 1368 |
| 400° F. without turning vanes | 1295 |

### Integrated Exhaust Fan Architecture and Supply Airflow Systems

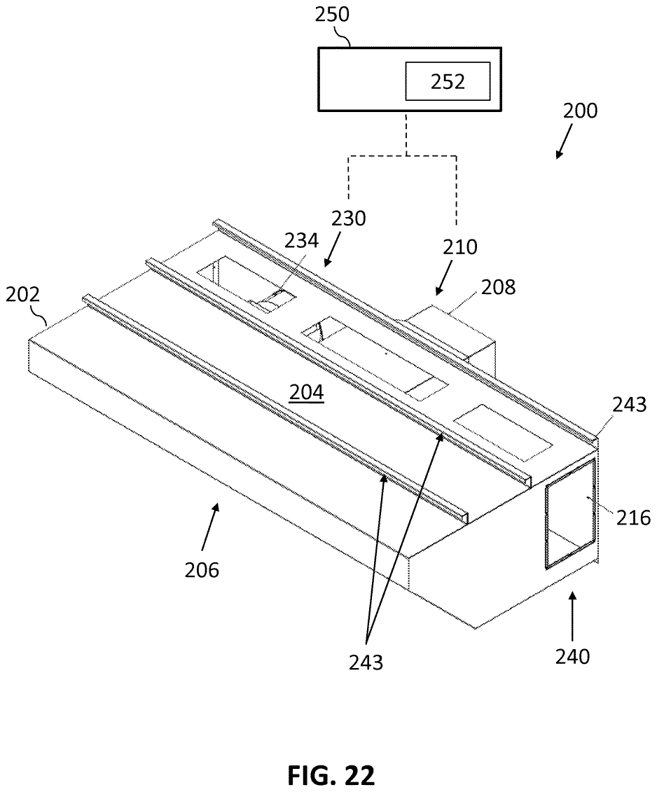

FIGS. 22-29 are directed to another embodiment with a hood system or a ventilation hood system 200 having an integrated exhaust system and a supply airflow system. The hood system 200 may include some or all of the components or systems discussed above for the hood 18. The hood system 200 may be used in any kind of kitchen or cooking surface, e.g., food trucks, mobile kitchens, industrial kitchens, restaurant kitchens, etc. Furthermore, the hood system 200 is configured to have equal or improved performance than conventional ventilation hood system and the hood 18 in some aspects. For example, the hood system 200 may be configured to provide improved grease management, easier installation, and upgraded ventilation performance when compared to conventional ventilation hood system and some embodiments of the hood 18.

Kitchen ventilation systems are used to capture and remove grease-laden vapors, smoke, heat, and other cooking effluent generated by cooking appliances. Conventional ventilation hood systems commonly rely on canopy structures connected to remote exhaust fans through field-installed ductwork (e.g., exhaust fans in external duct-mounted fan arrangements, exhaust fans external to the hood). In many installations, exhaust fans are mounted on rooftops or in mechanical rooms, necessitating considerable duct routing, structural coordination, and installation labor.

Traditional hood systems commonly incorporate passive grease filters positioned within the capture region to remove grease from the exhaust airstream. While such filters provide a degree of grease separation, substantial grease vapor and particulate matter may continue downstream into exhaust ductwork. This can lead to grease accumulation within ducts, increased maintenance requirements, and possible fire hazards.

In addition, conventional ventilation systems frequently require large exhaust duct transitions above the hood to achieve proper airflow velocities. This may increase the overall installed height of the system and limit use in retrofit installations where ceiling space or building construction constraints restrict available mechanical clearance.

Remote exhaust fan placement can also introduce serviceability challenges. Replacement or maintenance of rooftop or remotely located fans may require roof access, dedicated lifting equipment, or interruption of facility operations. In some installations, servicing exhaust system components may require removing portions of the hood or duct system. Furthermore, conventional hood installations typically require extensive field fabrication, welding, and alignment of duct components. Such installation practices may increase project duration, generate variability in installation quality, and raise overall project cost.

The hood system 200 is designed to address the above-mentioned limitations of the conventional ventilation hood systems. In one embodiment, the hood system 200 includes an integrated exhaust airflow architecture incorporating multi-stage grease-separation pressure chambers, centrifugal airflow characteristics, modular fan module replacement capability, and internal supply air introduction features to achieve improved grease management, easier installation, and improved ventilation performance. Specifically, the hood system 200 may incorporate integrated exhaust and supply airflow systems, multi-stage grease-separation airflow chambers, modular construction features, and a replaceable fan module architecture configured for installation within standard building conditions.

Referring to FIGS. 22-29, an example hood system 200 includes a hood body 202 configured to be mounted above one or more cooking appliances. The hood system 200 and the hood 18 may share many of the same terminology. For example, the hood body 202 is oriented with respect to the cooking effluent that enters the hood body 202 from a front side and exits the hood body 202 from a rear side. The hood body 202 is configured to function as ductwork for grease removal and temperature reduction. In particular, the hood body 202 functions as ductwork to direct and spin airflow, which leads to effective grease effluent removal from the kitchen environment. The hood body 202 is defined by side panels, a front panel, a top panel, a lower panel, and an angle panel extending from the rear side to the lower panel. These panels (the side panels, the front panel, the top panel, the lower panel, and the angle panel) are connected to one another to function as ductwork. These panels may be connected to one another using any suitable removably or non-removably mechanism for connecting the components to function as ductwork. For example, these panels may be connected via an adhesive, wedding, mechanical fastening, snap fit, interference fit, clearance fit, etc. These panels may be made of stainless steel, aluminized or galvanized steel, or other suitable materials. In an installed hood system 200, the side panels and the front panel are oriented vertically (e.g., vertical in relation to the cooking surface or the floor) and the top panel and the lower panel are oriented horizontally (e.g., horizontal in relation to the cooking surface or the floor). The side panels, the front panel, the top panel, the lower panel, and the angle panel are designed with desired dimensions to form an inlet that intakes the cooking effluent and suitable for the dimensions and/or configuration of the cooking space or area (e.g., a kitchen, a mobile kitchen, etc.).

The hood body 202 includes one or more chambers 203 (including an exhaust pressure chamber and a supply airflow chamber) configured to work collectively to allow compression or direction of the airflow or cooking effluent from inlet(s) to outlet(s). The hood body 202 defines an internal airflow passage 204 extending from a capture region 206 positioned above the cooking surface to facilitate cooking effluent passage from an inlet 207 into the hood system 200 and out from an exhaust outlet 208 configured to connect to building exhaust ductwork. In various embodiments, the hood body 202 functions as an integrated duct structure and may include internal structural panels, airflow partitions, the one or more pressure chambers 203, and transition sections formed from sheet metal components. The hood body 202 may be constructed in modular sections to facilitate transport through building access points and to allow field assembly or factory pre-assembly. Such modular construction may include separable canopy sections, removable exhaust transition modules, detachable pressure chamber assemblies, and standardized duct connection interfaces. Such modular architecture allows adaptation of hood length, airflow capacity, and configuration based on installation requirements. The hood system 200 may or may not include a baffle louver (e.g., the baffle louvers 96) attached to the exhaust outlet 208.

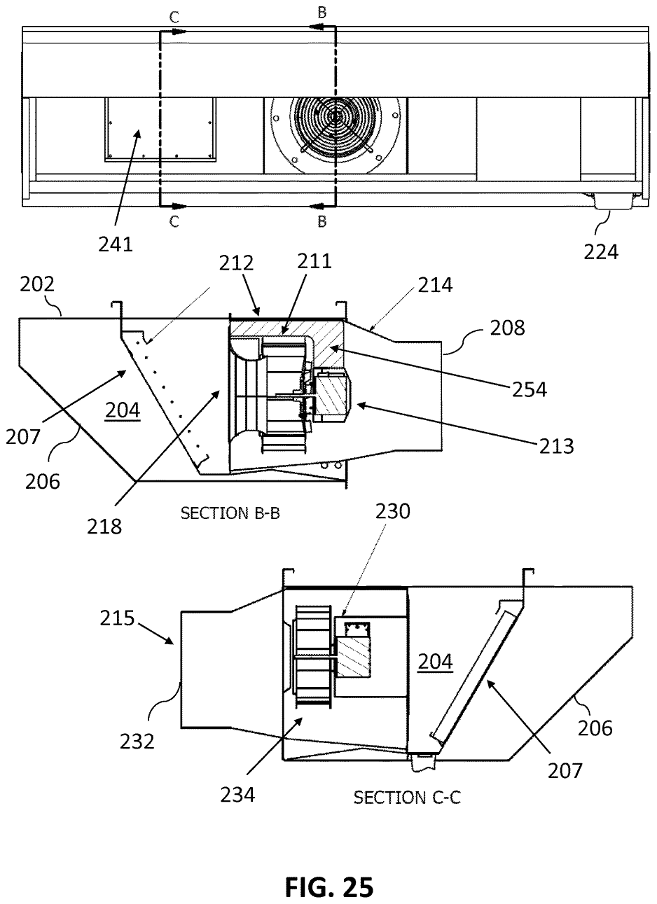

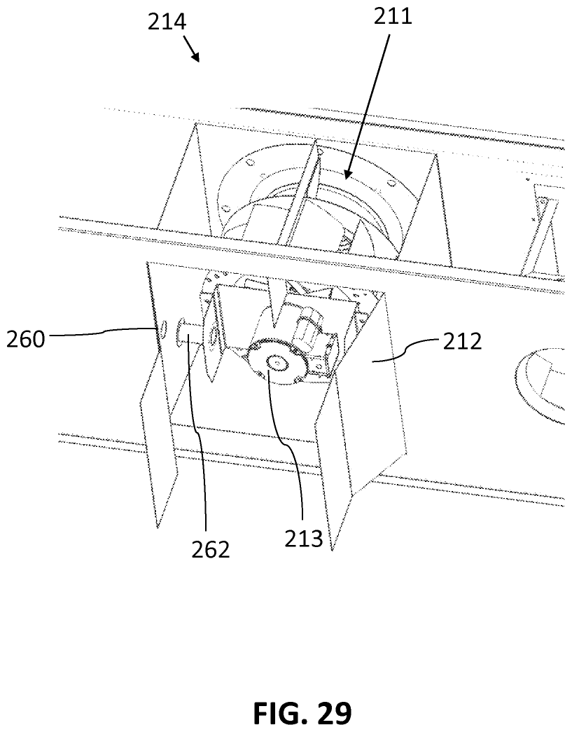

The hood system 200 includes an integrated exhaust fan architecture having an integrated exhaust fan assembly 210 operatively associated with the internal airflow passage 204 of the hood body 202. The exhaust fan assembly 210 may be positioned fully within the hood body 202, partially within the hood body 202, or within a fan housing 212 that forms a part of an exhaust pressure chamber 214 (of the one or more pressure chambers 203). In certain embodiments, the exhaust fan assembly 210 is configured as a removable fan module that may be accessed through service openings formed in the hood body 202. For example, an access door or panel 216 as shown in FIGS. 22-24 can be a service opening. The access door or panel 216 may be on one or both of the side panels. The exhaust fan assembly 210 may include hanging or mounting rails 243, lifting features, separable electrical connectors, and vibration isolation elements. The exhaust fan assembly 210 may include an inlet 218 and discharge transition sections 220 configured to align with adjacent pressure chambers (of the one or more pressure chambers 203) or building ductwork. The exhaust fan assembly 210 may be replaced as a single assembled unit without removing the entire hood system 200. The exhaust fan assembly 210 includes an exhaust fan 211 and a motor 213 (shown in FIGS. 25 and 29) and is configured to function as the blower assembly, e.g., the blower assembly 44 described above. The exhaust fan assembly 210 may include the same or similar components of the blower assembly 44, including but are not limited to the blower wheel 76, the motor 78, the primary blades 84, the secondary blades 94, and components shown in FIGS. 12 and 13.

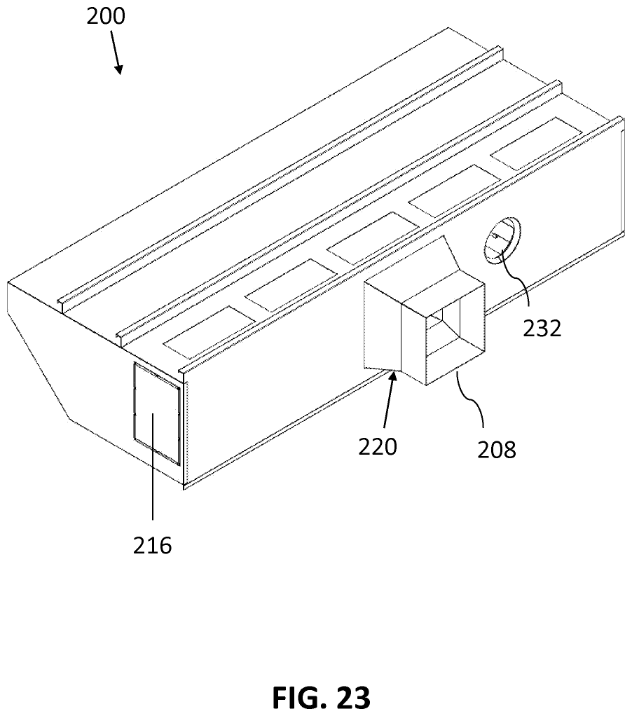

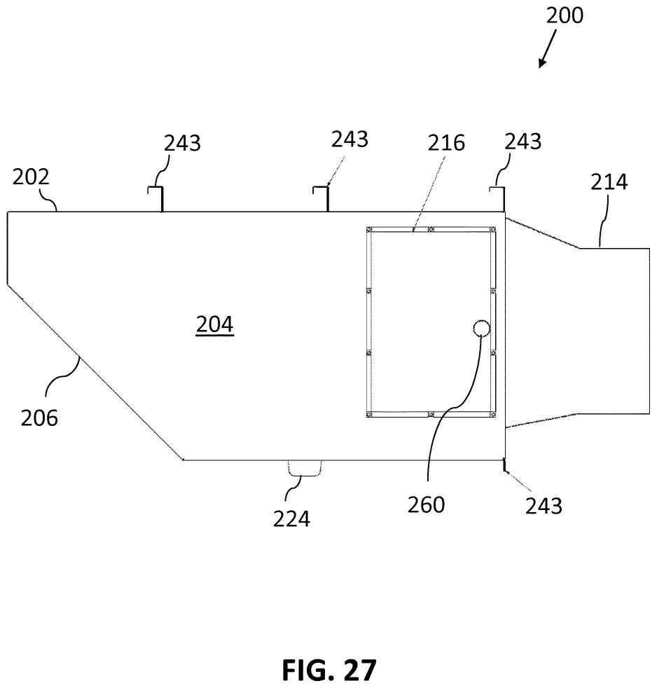

The hood system 200 includes multi-stage pressure chambers and configurations for improved grease separation. Upstream of the exhaust fan assembly 210, the internal airflow passage 204 may include the one or more pressure chambers 203 including an exhaust pressure chamber 214 configured to alter airflow velocity, direction, and/or rotational characteristics. In certain embodiments, the exhaust pressure chamber 214 includes a tapered geometry 222 that reduces cross-sectional area in the downstream exhaust direction (as shown in FIGS. 23-26). The exhaust pressure chamber 214 has a tapered flow passage that a cross-sectional area of flow decreases in a downstream direction, which forms the multi-stage pressure chamber configuration. The tapered pressure chamber increases the airflow velocity and promotes inertial separation of grease particles. In further embodiments, the exhaust pressure chamber 214 may be configured to induce swirling or rotational motion in the internal airflow path 204, thereby generating centrifugal forces that cause grease droplets and particulate matter to migrate toward chamber walls. Grease separated from the airflow may be directed toward grease collection features, including troughs, drains, reservoirs, or removable grease containers, such as a grease collection tray 224 as shown in FIGS. 25 and 27. The grease collection tray 224 can be easily removed and cleaned, making maintenance of the hood system 200 easier and less time-consuming. The exhaust fan assembly 210 may include blower features as discussed for the blower assembly 44 in FIGS. 8, 9, 12, and 13. For example, the exhaust fan assembly 210 may include grease extraction features 223 (e.g., rotating secondary blades 94) configured to induce rotational grease extraction. In certain embodiments, the exhaust fan assembly 210 may include an air passage but exclude a metal mesh at the inlet 218. The multi-stage pressure chamber configuration allows sequential removal of grease particles before exhaust air is discharged out of the hood system 200. In certain embodiments, internal chamber surfaces of the one or more pressure chambers 203 including the exhaust pressure chamber 214 may be smooth or contoured to reduce grease accumulation and facilitate cleaning.

The hood system 200 includes overlapping exhaust duct connection interfaces configured to permit field assembly and removal of exhaust components. Such interfaces may include telescoping sections, slip-fit joints secured by mechanical fasteners, flanged connections, or combinations thereof. In some embodiments, at least a portion of the fan housing 212 or at least a portion of the exhaust pressure chamber 214 (of the one or more pressure chambers 203) may be formed of overlapping duct connections to allow adjustment of exhaust duct length, angle and orientation, alignment tolerance during installation, and removal of the exhaust fan assembly 210 without cutting or welding duct sections. In some embodiments, the hood system 200 is configured to reduce field welding requirements. Sealing features such as gaskets, sealants, or compression joints may be provided (along the duct connection interfaces) to maintain grease-resistant airflow containment. These connection interfaces enable modular transport, simplified field installation, and improved serviceability.

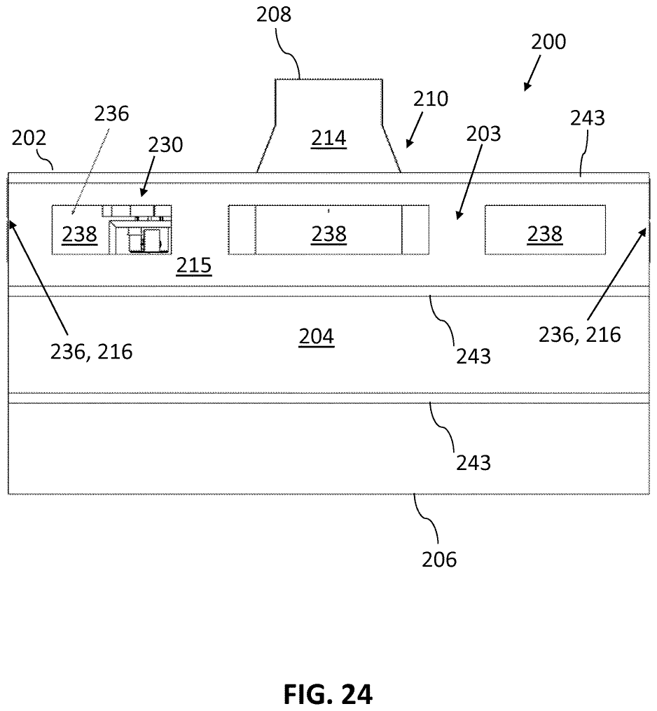

The hood system 200 includes an integrated supply air system 230 configured to introduce replacement air from the ambient environment through an inlet 232 (as shown in FIGS. 23 and 25) into the hood body 202. The one or more chambers 203 include a supply airflow chamber 215, and the supply air system 230 is configured to flow ambient air into and out of the supply airflow chamber 215. The supply air system 230 includes a supply fan 234 that may be mounted within or adjacent to the hood structure and connected to one or more internal plenums. The supply air may be discharged through air discharging features 236, such as perforated panels or sections, directional slots, diffusers, or adjustable airflow outlets. In the illustrated embodiment shown in FIG. 24, the air discharging features 236 include perforated panels or sections 238 at the top surface of the hood body 202. In some embodiment, at least a portion of one or both of the side panels of the hood body 202 may be perforated. In some embodiment, at least a portion of one or both of the access doors or panels 216 are perforated. In certain embodiments, supply air may form an air curtain along a front or side edge of the hood capture region 206 to improve containment of cooking effluent. The supply air system 230 may be configured to operate in coordination with the exhaust fan assembly 210 to sustain desired airflow balance and capture performance. The perforated panels or sections 238 are configured to allow air flow between the supply airflow chamber 215 and the ambient.

One or both of the exhaust pressure chamber 214 and the supply airflow chamber 215 may have smooth internal transitions. One or both of the exhaust chamber 214 and the supply airflow chamber 215 may have smooth internal surfaces. One or both of the exhaust chamber 214 and the supply airflow chamber 215 may have tapered geometry that is linear, stepped, or curved. In some embodiment, the presence of the exhaust fan assembly 210 eliminates a requirement for a remote rooftop fan. The supply fan 234 may be mounted within the hood body 202 and the supply air is introduced through a perforated plenum.

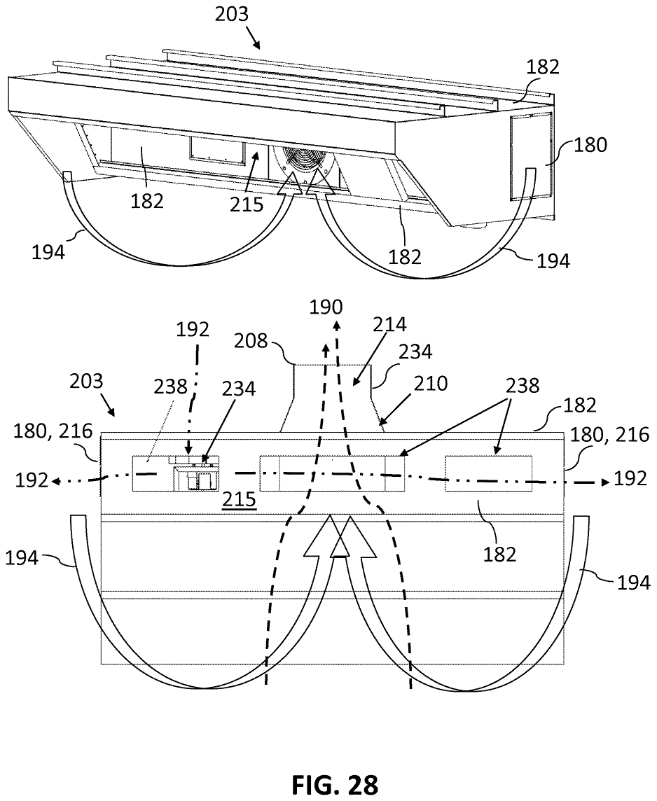

FIG. 28 shows an exemplary illustration of the air curtain created by the exhaust fan assembly 210 and the supply air system 230. The one or more pressure chambers 203 (including the exhaust pressure chamber 214 and the supply airflow chamber 215) are coupled to the exhaust fan assembly 210 and the supply fan 234 and are configured to allow compression of the cooking effluent to increase the efficiency of the exhaust fan assembly 210 to exhaust the cooking effluent out of the cooking area. In the illustrated example, the one or more pressure chambers 203 include the exhaust pressure chamber 214 and the supply airflow chamber 215. The supply airflow chamber 215 may generally be a right rectangular prism in shape (e.g., two parallel end faces 180 and four lateral faces 182; the faces are perpendicular to each of its base) and are configured to function as ductwork. In the illustrated example in FIG. 28, at least a portion of the exhaust pressure chamber 214 is disposed inside the supply airflow chamber 215. The suction or pressure difference generated by the exhaust fan assembly 210 pulls the cooking effluent from the space enclosed by the hood body 202 in the front side through the inlet 218 into the exhaust pressure chamber 214 and exit through the exhaust outlet 208 as indicated by arrows 190. The exhaust fan assembly 210 is relatively at the center of of the supply airflow chamber 215 between the two parallel end faces 180. The supply air system 230 is within the supply airflow chamber 215 adjacent to the exhaust pressure chamber 214. The suction generated by the supply air system 230 pulls ambient air into the supply airflow chamber 215, discharged through the perforated panels 238 and through the perforations of the access door or panels 216 as indicated by arrows 192. The air flows created by the exhaust fan assembly 210 and the supply air system 230 collectively may form an air curtain (as indicated by arrows 194) along a front edge and/or side edges of the hood capture region 206 to improve containment of cooking effluent. Herein an air curtain refers to a directionally controlled, high-velocity airstream in close proximity of the hood body 202 to create an invisible barrier or airflow field to improve containment of the cooking effluent. In FIG. 28, the grease baffle filters (e.g., the grease baffle filters 38) are omitted to show the supply airflow chamber 215.

The hood system 200 includes serviceability features 240, including but are not limited to, service access panels, removable grease collection elements, clean-out openings, and fan module access ports. These features allow inspection and maintenance of internal airflow passage 204, the one or more pressure chambers 203 (including the exhaust pressure chamber 214 and the supply airflow chamber 215), and fan components (of the exhaust fan assembly 210 and/or the supply air system 230) without removal of the hood system 200 from its installed position and without cutting the duct. In certain embodiments, modular pressure chamber components or grease separation cartridges may be removable for cleaning or replacement. For example, the serviceably features 240 include the access doors or panels 216 on the side of the hood body 202 as shown in FIG. 22. For example, the serviceably features 240 include an access door or panel 241 to allow easy access to the supply air system 230 as shown in FIG. 25.

The hood system 200 includes retrofit installation features configured to allow installation within existing building structures. For example, the retrofit installation features may include but are not limited to reduced height exhaust transitions, compact fan placement, tapered internal duct geometry, and modular assembly features allowing installation within ceiling cavities, mechanical chases, or other constrained spaces. Standardized duct connection interfaces allow the hood system 200 to connect to existing building exhaust systems without major structural modification. The hood system 200 may include one or more hanging rails 243 (e.g., integrated hanging rails and wall mounting rails) for mounting or installation of the hood system 200.

The hood system 200 includes an integrated control system 250 (see FIG. 22) that is operatively connected to the exhaust fan assembly 210 and supply air system 230 to regulate airflow operation. The control system 250 includes one or more sensors 252 (e.g., temperature sensors, pressure sensors, optical sensors, etc.) arranged to monitor at least one airflow parameters selected from airflow rate or speed, airflow temperature, airflow volume, and airflow pressure of the hood system 200 and to generate corresponding sensor signals. The one or more sensors 252 may be arranged at any point(s) along the air passage in and/or out of the hood system 200 to monitor at least one airflow parameter (at or near an inlet and/or outlet of the exhaust fan assembly 210, at or near an inlet and/or outlet of the supply air system 230, or along any point along the internal airflow passage 204). The control system 250 is configured to receive the sensor signals and based at least in part thereon, control operation of the exhaust fan assembly 210 and the supply air system 230, including adjusting a speed and/or output of each fan system, such that the exhaust fan assembly 210 and the supply air system 230 are operated in a coordinated and collective manner (at least in part based on analysis of the sensor signals or data collected by the one or more sensors 252) to achieve a desired airflow condition. In some embodiments, at least a portion of electrical components associated with the control system 250, the exhaust fan assembly 210, and the supply air system 230 are pre-wired during manufacture to reduce field installation labor and complexity. The control system 250 further includes one or more stored control algorithms and/or preset operating parameters configured to coordinate operation of the exhaust fan assembly 210 and the supply air system 230 to maintain or achieve the desired airflow condition.

The control system 250 may be a computer or may include any suitable processer(s), microprocessor(s), transceiver(s), memory, a timer, analog-to-digital convertor(s) (ADC), programmable logic controller(s) (PLC), human machine interface(s) (HMI), etc. to enable its functions as disclosed and claimed. The control system 250 may further include any suitable user interface and/or display to allow output of the test results and allow a user to program or control the operation of the hood system 200. The control system 250 may be positioned outside grease-laden airflow regions and accessible through the serviceability features 240 such as service panels.

The hood system 200 may be implemented in various configurations and structural arrangements based on installation requirements while maintaining the integrated exhaust fan architecture, multi-stage grease-separation airflow paths, and modular, serviceable construction principles described above. Exemplary configuration and structural arrangement variations are provided below, including but are not limited to exhaust fan position variations, pressure chamber geometry variations, supply air introduction variations, modular construction variations, fan module replacement architecture variations, retrofit installation variations, serviceability variations, and operational variations.

In certain embodiments, the integrated exhaust fan assembly 210 may be positioned downstream (i.e., downstream of the cooking effluent flow) in the exhaust pressure chamber 214. In some embodiments, the exhaust fan assembly 210 is downstream of a tapered portion of the exhaust pressure chamber 214. In alternative embodiments, the exhaust fan assembly 210 may be positioned upstream (i.e., upstream of the cooking effluent flow) of the exhaust pressure chamber 214 to influence airflow distribution and rotational flow characteristics. In further embodiments, the hood system 200 may include multiple exhaust fan assemblies 210 provided in series to increase pressure capability or in parallel to increase airflow capacity. The exhaust fan assemblies 210 may be located within a common airflow chamber (of the one or more pressure chambers 203) or in separated airflow passages within the hood body 202. The exhaust fan assembly 210 may be mounted in a horizontal orientation, vertical orientation, or at an inclined angle relative to the hood canopy. In some embodiments, the exhaust fan assembly 210 includes a structural arrangement feature 254 configured to occupy the head space (the top space) of the exhaust pressure chamber 214 as shown in FIG. 25. The structural arrangement feature 254 may be a hollow housing structure, a solid structure, or a partial solid/solid structure, configured to block the airflow from entering the upper or top portion of the space between the exhaust fan 211 and the top wall and at least a portion of the side walls of the fan housing 212. In some embodiment, the exhaust fan 211 may be removably mounted and the exhaust fan assembly 210 is formed of removably mounted integrated module and the exhaust pressure chamber 214 forms part of the internal airflow passage 204 and overlaps duct connection interface.

The grease separation architecture may include the one or more pressure chambers 203 (including the exhaust pressure chamber 214 and the supply airflow chamber 215) having tapered, expanding, cyclonic, offset, or multi-directional flow geometries. In the illustrated example, the exhaust pressure chamber 214 has the tapered geometry 222. In other embodiments, the exhaust pressure chamber 214 may have an expanding geometry, a cyclonic geometry, an offset geometry, or multi-directional flow geometries. In some embodiments, same or similar variations (e.g., tapered geometry, expanding geometry, cyclonic geometry, an offset geometry, multi-directional flow geometries) may be incorporated for the supply airflow chamber 215. In addition, internal vane structures, airflow turning surfaces, or curved chamber walls as discussed for the hood 18 may be used for the hood system 200 to induce rotational airflow motion. The one or more pressure chambers 203 (including the exhaust pressure chamber 214 and the supply airflow chamber 215) may be arranged in series to provide progressive grease removal stages or may be configured in parallel airflow paths to reduce pressure drop. In certain embodiments, removable pressure chamber modules or grease separation cartridges may be provided to allow periodic cleaning or replacement.

Replacement air may be introduced through front-edge plenums, rear plenums, side plenums, perforated ceiling sections (e.g., the perforated panels or sections 238) of the hood body 202, or directional slot diffusers. Supply airflow may be configured to form one or more air curtains (indicated by arrows 194) surrounding the capture region 206, or may be distributed to promote blending within the supply airflow chamber 215 or within the hood body 202. The supply air system 230 is configured to create an air curtain across a hood edge. In some embodiments, the supply air system 230 may include multiple supply fans or adjustable airflow distribution mechanisms. The supply air system 230 may be configured to reduce conditioned air loss.

The hood body 202 may be constructed from modular sections joined through mechanical fasteners, overlapping seams, flanged joints, or interlocking structural features. Modular sections may include canopy modules, pressure chamber modules, fan modules, duct transition modules, and supply air plenum modules. Modular construction may allow adjustment of hood length, airflow capacity, and exhaust outlet position to suit installation conditions. The hood body 202 may be configured to have suitable geometry to reduce exhaust transition height to allow ceiling cavity installation.

The exhaust fan assembly 210 may be configured as a removable cartridge assembly mounted on sliding rails, pivot mounts, or detachable support frames. Electrical connections may be provided through plug-in connectors, terminal blocks, or quick-disconnect harnesses. Overlapping duct connection interfaces may include telescoping round duct sections, rectangular slip joints, gasketed flange assemblies, or flexible transition elements. Such interfaces may allow axial movement, rotational alignment adjustment, or tolerance compensation during installation. In some embodiments, the hood body 202 (e.g., the exhaust pressure chamber 214 and the supply airflow chamber 215) may include standardized duct connection geometries.

The hood system 200 may be configured for installation within ceiling cavities, soffits, mechanical chases, or suspended support structures. Reduced-height exhaust transitions and offset exhaust outlets may be provided to accommodate construction constraints. In certain embodiments, the exhaust outlet 208 may be positioned at the rear, top, or side of the hood body 202. The hood system 200 may be configured such that installation is possible without rooftop duct routing. The hood system 200 may be configured such that the hood body 202 can pass through a standard commercial doorway. The hood system 200 may include factory installed wiring.

Service access may be provided through front panels, side panels, bottom clean-out openings, or removable filter assemblies. In some embodiments, the exhaust fan 211 and/or the supply fan 234 are removable through service access or opening, such that hood removal is not required for fan replacement. In some embodiment, the hood system 200 may include lifting features that are configured to assist the removal. Grease drainage components may include fixed troughs, removable trays, or centralized drainage manifolds. Fan modules, pressure chamber components, and supply air distribution elements may be independently removable.

The hood system 200 may incorporate airflow control devices, including dampers, variable-speed drives, temperature sensors, optical sensors, or pressure sensors. Control components of the control system 250 may be mounted remotely or integrated into the hood body 202 outside grease-laden airflow regions. Operation of supply and exhaust airflow systems may be coordinated through programmable or electromechanical control strategies. In some embodiment, the operation of the exhaust fan assembly 210 and/or the operation of the supply air system 230 may be controlled and coordinated by the control system 250 based on cooking activity.

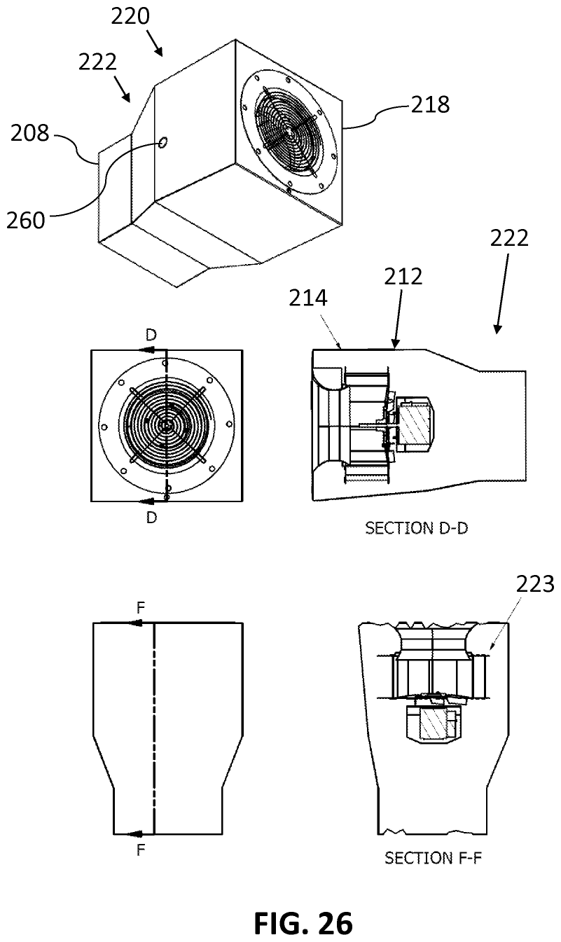

The hood system 200 may be configured to achieve equal or better performance than the hood 18. The hood system 200 may be configured to achieve better performance than conventional hood systems. For example, for effluent including grease particle size of about 8 micrometer (μm)-10 μm, the grease extraction efficiency may be about 70% for a conventional hood system while the hood system 200 may be configured to improve the grease extraction efficiency to about 75% to about 95%, about 80% to about 90%, about 85% to about 90%, or about 90%. For example, for effluent including grease particle size of about 3 nanometer (nm), the grease extraction efficiency may be about 7% for a conventional hood system while the hood system 200 may be configured to improve the grease extraction efficiency to about 30% to about 70%, about 40% to about 60%, about 45% to about 55%, or about 50%. In some embodiments, referring to FIGS. 26, 27, and 29, cooling features including one or more opening 260 and one or more tubes 262 are added to the exhaust pressure chamber 214 (or the fan housing 212) to flow air from the supply airflow chamber 215 into the exhaust pressure chamber 214 to cool the motor 213 the exhaust fan assembly 210. The temperature of the motor 213 may be around 280 degree Fahrenheit (° F.) when the hood system 200 is under a normal operation range. With the addition of the cooling features, the temperature of the motor 213 under normal operation range may be reduced to about 100° F. to 140° F., about 110° F. to 130° C., about 120° F. to 130° F., or about 125° F.

In some embodiment, a method of using the hood system 200 may include ventilating a cooking appliance by installing the hood system 200 with the integrated exhaust fan 211, the tapered exhaust pressure chamber 214, exhausting cooking effluent, introducing supply air, and discharging air into existing ductwork.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. A ventilation hood system, comprising:
a hood body defining an exhaust pressure chamber and a supply airflow chamber;
an exhaust fan assembly configured to generate a pressure difference to pull cooking effluent into the exhaust pressure chamber and flow out of the ventilation hood system; and
a supply air system configured to pull an ambient air into the supply airflow chamber and flow out of the ventilation hood system.

2. The ventilation hood system of claim 1, wherein the hood body is configured to function as a duct system to:
guide the cooking effluent to flow into the exhaust pressure chamber and and out of the ventilation hood system from an exhaust outlet; and
facilitate installation coupling to another structure.

3. The ventilation hood system of claim 1, wherein the exhaust pressure chamber has a tapered flow passage in which a cross-sectional area of flow decreases in a downstream direction.

4. The ventilation hood system of claim 1, wherein the exhaust fan assembly is inside the exhaust pressure chamber downstream an inlet of the exhaust pressure chamber.

5. The ventilation hood system of claim 1, wherein at least a portion of the exhaust pressure chamber is disposed inside the supply airflow chamber.

6. The ventilation hood system of claim 1, comprising one or more tubes configured to flow air from the supply airflow chamber into the exhaust pressure chamber.

7. The ventilation hood system of claim 1, wherein the hood body comprises perforated sections configured to allow airflow between the supply airflow chamber and an ambient environment.

8. The ventilation hood system of claim 1, wherein the exhaust pressure chamber is formed of modular hood body sections.

9. The ventilation hood system of claim 1, wherein the hood body comprises an access door to allow access to the supply air system.

10. The ventilation hood system of claim 1, comprising a control system operatively connected to the exhaust fan assembly and the supply air system.

11. The ventilation hood system of claim 10, wherein at least a portion of electrical components associated with the control system, the exhaust fan assembly, and the supply air system are pre-wired.

12. The ventilation hood system of claim 10, wherein the control system comprises one or more sensors configured to monitor at least one airflow parameters of the ventilation hood system selected from airflow rate or speed, airflow temperature, airflow volume, and airflow pressure.

13. The ventilation hood system of claim 12, wherein the control system is configured to control and adjust operation of the exhaust fan assembly and the supply air system in a coordinated and collective manner based at least in part on analysis of data collected by the one or more sensors.

14. The ventilation hood system of claim 10, wherein the hood body comprises an access door to allow access to the control system.

15. The ventilation hood system of claim 1 is configured to achieve a grease extraction efficiency of about 75% to about 95%.

16. The ventilation hood system of claim 1, wherein temperature of a motor of the exhaust fan assembly is between about 100 degree Fahrenheit (° F.) to about 140° F. during operation of the ventilation hood system.

17. The ventilation hood system of claim 1, wherein the exhaust fan assembly comprises:
a motor; and
a blower wheel comprising:
primary blades configured to pull the cooking effluent from an inlet into the exhaust pressure chamber; and
secondary blades configured to pull an ambient air flowing through a rear side of the hood body adjacent to the motor and into the exhaust pressure chamber, wherein the blower assembly is configured to disperse the cooking effluent and the ambient air radially outward in a direction perpendicular to a center axis of the blower wheel such that the cooking effluent is expelled away from the motor.

18. A mobile kitchen comprising a ventilation hood system, comprising:
a hood body defining an exhaust pressure chamber and a supply airflow chamber;
an exhaust fan assembly configured to generate a pressure difference to pull cooking effluent into the exhaust pressure chamber and flow out of the ventilation hood system; and
a supply air system configured to pull an ambient air into the supply airflow chamber and flow out of the ventilation hood system.

19. The mobile kitchen of claim 18, wherein the exhaust fan assembly comprises:
a motor; and
a blower wheel comprising:
primary blades configured to pull the cooking effluent from an inlet into the exhaust pressure chamber; and
secondary blades configured to pull an ambient air flowing through a rear side of the hood body adjacent to the motor and into the exhaust pressure chamber, wherein the blower assembly is configured to disperse the cooking effluent and the ambient air radially outward in a direction perpendicular to a center axis of the blower wheel such that the cooking effluent is expelled away from the motor.

20. The mobile kitchen of claim 18, wherein the ventilation hood system comprises a control system operatively connected to the exhaust fan assembly and the supply air system.
